(19) United States
(12) Patent Application Publication
(10) Pub. No.: US 2005/0064859 A1
(43) Pub. Date: Mar. 24, 2005

(54) Server-based system for backing up memory of a wireless subscriber device

(75) Inventors: Michael D. Kotzin, Buffalo Grove, IL (US); John D. Bruner, South Barrington, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/669,020

(22) Filed: Sep. 23, 2003

(51) Int. Cl. H04M 3/00

(52) U.S. Cl. 455/419; 455/418

(57) ABSTRACT

A system including a backup server (111) and corresponding methods (FIG. 4, FIG. 5), for backing up a memory (207) of a wireless subscriber device (101). The method involves creating an archived representation of the memory image (405, 505) in a backup server and scanning modified representations of the memory image (407, 507) for abnormalities, such as viruses or other malicious files. If a problem has occurred, the memory of the wireless subscriber device can be restored (409, 509) using an archived representation of the memory image.

### FIELD OF THE INVENTION

The present invention relates to wireless communications, and more specifically to a method and apparatus for backing up the memory of a wireless subscriber device.

### BACKGROUND OF THE INVENTION

With recent advances in technology, mobile, wireless, and handheld computing devices (wireless subscriber devices) have become more complex with larger memories and memory contents and additional functionality, such as access to the World Wide Web. Many wireless subscriber devices can be used to surf the Internet and download files or open email attachments by using a micro web browser located within such wireless subscriber devices.

This additional complexity and functionality comes at additional risk to the memory integrity or integrity of the memory contents. For instance, surfing the Internet or Web and downloading content or programs can subject wireless subscriber devices to potential problems, such as viruses. Once a virus is downloaded to a wireless subscriber device, besides damage that may be done to the device memory contents, the virus may also be transmitted to other devices connected to the wireless subscriber device. While virus protection software exists for personal computers for example, the memory space and processing capacity required for execution of such software on a wireless device can be overly burdensome. Furthermore updating such software from a wireless device on a routine basis can place a large load on the wireless network.

Computers are often backed up. For example a computer used in a professional environment is often routinely and periodically backed up to a local network server. Individual users often locally back up current work product to a diskette or other removable media in order to avoid lost time in the event of a system failure or other anomaly. These approaches can be used to restore or recover files that may be lost or corrupted for any number of reasons, including a virus. Conceivably a subscriber could back up the memory of their wireless subscriber device to a personal computer (PC). For this to work appropriately the back ups would have to be frequent and routine which places a significant burden on the user of the device. Furthermore this does not avoid a problem in the first place.

However, failure to incorporate antivirus features into wireless services could put the security of wireless subscribers in jeopardy, as a virus can erase all the data in memory or corrupt the memory so that it is no longer accessible and cause improper operation of the device. As wireless subscribers increasingly access information on the Internet, the possibility of downloading a virus or malicious software may also increase. Consequently, it will be necessary to protect wireless subscribers without excess airtime usage and resources.

Therefore, what is needed is a method and system for backing up and otherwise protecting the integrity of the memory of a wireless subscriber device.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram of an exemplary wireless communication environment capable of enabling memory backup and virus checking;

FIG. 2 is a diagram of an exemplary wireless subscriber device suitable for use in the environment of FIG. 1;

FIG. 3 is a diagram of an exemplary display on the wireless subscriber device of FIG. 2;

FIG. 4 is a flow diagram of a method embodiment for maintaining the integrity of the memory of a wireless subscriber device in the environment of FIG. 1; and

FIG. 5 is a flow diagram of a method embodiment for backing up the memory of a wireless subscriber device in the environment of FIG. 1.

### DETAILED DESCRIPTION OF PREFERRED EMBODIMENTS

In overview, the present disclosure concerns systems, methods, and equipment or apparatus that provide communications services to subscribers of such systems as well as equipment and specifically techniques for implementing memory backup, preferably including virus checking and the like capabilities. More particularly, various inventive concepts and principles embodied in systems, wireless subscriber devices, and methods therein for providing, initiating, or facilitating novel and faster memory backup and virus screening are discussed and described. Note that the wireless subscriber devices for providing or facilitating memory backup and virus checking and other services can be a variety of devices. Such wireless subscriber devices include, for example, personal digital assistants, personal messaging units, personal computers, wireless handsets or devices, or equivalents thereof, provided such devices are arranged and constructed in accordance with the principles and concepts described herein and for operation in a network, preferably a wireless network, such as a wide area network or local area network.

The communications systems and wireless subscriber devices that are of particular interest are those that may provide or facilitate voice or data or messaging services over wide area networks (WANs). Such conventional two way systems and devices include various cellular phone systems including analog and digital cellular, CDMA (code division multiple access) and variants thereof, GSM, GPRS (General Packet Radio System), 2.5 G and 3G systems such as UMTS (Universal Mobile Telecommunication Service) systems, integrated digital enhanced networks and variants or evolutions thereof. Furthermore, the wireless subscriber devices of interest can have short range communications capability normally referred to as W-LAN capabilities, such as IEEE 802.11, Bluetooth, or Hiper-Lan and the like that preferably utilize CDMA, frequency hopping, or TDMA access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System), or integrated digital enhanced network (iDEN™) protocol.

As further discussed below, various inventive principles and combinations thereof are advantageously employed for memory backup of a wireless subscriber device thereby mitigating for example undesirable effect of viruses and the like. Note that this general rule may have various exceptions where virus checking is not necessary such as when the cellular network automatically downloads software updates to wireless subscriber devices and others that will be further explained and developed below. In this manner, a wireless subscriber can download software to the wireless subscriber device and yet appropriate levels of security or protection against viruses and other calamities can be maintained provided the principles or equivalents thereof as discussed below are utilized.

The instant disclosure provides further explanation in an enabling fashion of the best modes of making and using various embodiments in accordance with the present invention. The disclosure further offers to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

FIG. 1 shows typical components of a wireless communications system 100 in accordance with an illustrative embodiment that will be discussed and described. The wireless communication system 100 is compliant with one or more air interface standards, such as GSM, CDMA, or the like, and is capable of providing two-way voice or data communications, or both, between various users of the system or other telecommunications systems.

The wireless communications system 100 supports and services a plurality of wireless communications units or devices with a wireless subscriber device 101 depicted that is arranged to and capable of requesting and receiving downloads such as emails, files, software programs, upgrades, and the like from any of a plurality of servers or download servers, such as a download server 109 through a communication link established with a cell network 107 through a base station 103 as is known. Further, the wireless communication system 100 also includes a backup server 111, coupled through the cellular network 107, that backs up memory contents of and otherwise protects the wireless subscriber device 101 from, for example viruses or other malicious files either directly or indirectly through the cell network 107. Each of these elements or components of the wireless communication system 100 will be described in more detail below.

The wireless subscriber device 101 represents any type of wireless unit or device, such as wireless phones, radiotelephones including those adapted for coupling with data terminals (e.g., portable computers), dedicated data units (e.g., personal digital assistants), or wireless adapter devices (e.g., wireless modems adapted for coupling with computers, message pads, etc.) capable of establishing a communication link over a network. Note that network includes networks, such as the cell network 107 and the cell network 107 can be a conventional cellular system or network as well as picocell based networks, such as can be found in W-LANs, based, for example, on IEEE 802.11 typically available at coffee shops and similar venues. In any event, the wireless subscriber device 101 typically includes a transceiver and processor (not shown) appropriately arranged, operable, and programmed for wireless communications according to a serving system's air interface protocols. The wireless subscriber device 101 runs an application program such as a micro web browser or email application to communicate with a web site, an Internet site, an intranet site or other application program provided by or through the download server 109. Only when the wireless subscriber is actively selecting a link or downloading information is a communication path established to support the connection to the download server 109.

The download server 109 may be any of a plurality of remote servers that is available to anyone's browser on the WWW, Internet, etc. including those possibly maintained by a wireless service provider. These servers may be accessible for no charge or on a usage basis depending on, for example, terms of a wireless subscriber's rate plan with the wireless service provider as well as the server provider. The download server 109 is typically owned and maintained by a third party and is accessible through a network connection from the cell network. The download server 109 includes a processor (not shown) that executes and coordinates the tasks requested and required of the download server 109. The download server 109 typically initiates the download procedure for wireless downloads to the wireless subscriber device 101, normally responsive to a query from the device. As noted above these downloads may represent all sorts of files such as for example, upgrades to the operating system, emails, games, documents, and broadcast messages. The download server may also be arranged and constructed to operate in a push mode wherein downloads to the communications device are initiated by the server. For example a processor (not shown) in the download server 109 can scan a subscriber database (not shown) so as to determine whether wireless subscriber device 101 requires a download. This determination would occur, for example, if a subscriber record (not shown) indicates that a wireless subscriber has a certain version of software for some application but requires or would benefit from a more up-to-date version. Generally the servers or download server are known in the art and available from numerous suppliers.

The cell network 107 is known, apart from the concepts and principles disclosed herein and manages or provides communications with the communications devices and supplies certain information to the wireless subscriber device 101 for configuration thereof. The base station 103, actually a portion of a radio access element of the cell network, has a corresponding coverage area that defines the region within which the wireless subscriber device 101 can communicate with the base station 103. This coverage area for base station 103 together with all other base stations and their respective coverage areas forms a coverage area for the cell network 107. The base station 103 and base station controller 105 are known in the art and available from numerous manufacturers. The base station 103 broadcasts radio signals to and receives signals from the wireless subscriber device 101. The base station 103 is defined herein to mean a communication apparatus having or supporting at least one air interface with the wireless subscriber device 101 and at least one air or wired interface to the balance of the cell network 107.

Base station controller 105 may include at least one processor (not shown) and one or more memories (not shown) and is the central control for the base station 103 and thus involved in the majority of downloads from the download server 109. Base station controller 105 is in communication with a plurality of transceivers (not shown) associated with base station 103, along with one or more processors (not shown) and associated memories (not shown). Additional base station controllers 105 and base stations 103 are usually part of the cellular network 107.

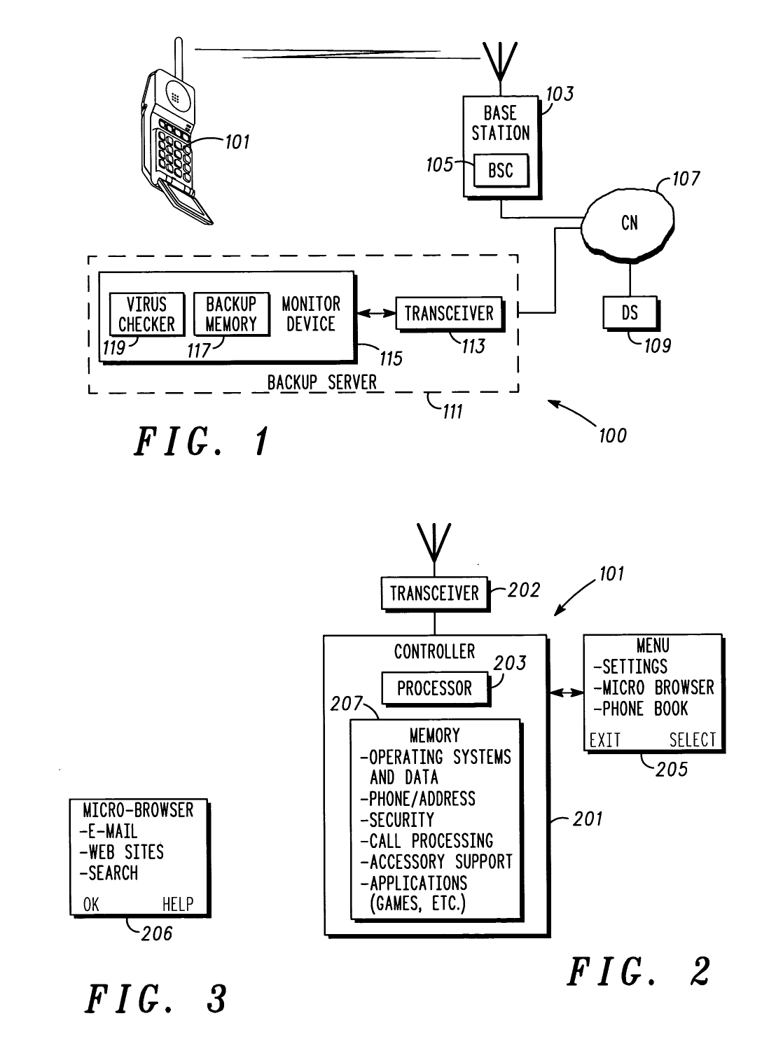

The backup server 111 backs up data, such as the contents of the memory 207 (see FIG. 2) of the wireless subscriber device 101, and operates to provide this data via the cell network and base station 103 to the wireless subscriber device 101 in the event of an abnormality or corruption of the memory (memory contents). More servers may be added to a server cluster (not shown) in order to provide a greater fault tolerance in case of a server failure. The backup server 111 is coupled to the cell network 107 and thus to the download server 109 and includes a transceiver 113 of the type known in the art.

The transceiver 113 enables or supports network communications through the cell network 107 between the backup server and the wireless subscriber device 101. The transceiver 113 is coupled to and exchanges information with the monitor device 115, which allows or provides for monitoring downloaded files to the wireless subscriber device 101. The monitor device 115 as coupled to the transceiver is operable for monitoring the wireless subscriber device to detect whether a memory of the wireless subscriber device has been compromised. The monitor device 115 is adapted to store or write relevant portions of the information received via the transceiver 113 in various locations in the backup memory 117. The backup memory 117 is coupled to the monitor device 115 and stores backup data related to a memory or contents of the memory (discussed later) of wireless subscriber device 101 as controlled by the monitor device 115.

The backup server 111, in some embodiments, can also include a virus checker 119. The virus checker 119 is usually a software application executed on a processor that is part of the backup server 111 as is known. The virus checker is normally updated with new virus definitions and scanning procedures and rules also as known. The virus checker 119 can scan updated memory images corresponding to the wireless subscriber device 101 to detect whether malicious code, such as a virus or damage from a virus is present. Thus the virus checker 119 coupled to the monitor device 115 operates to protect the wireless subscriber device 101 from viruses or the results of viruses based on the backup data or memory images related to the memory (described later) of the wireless subscriber device 101. The virus checker 119 can also intercept and scan downloaded files for viruses and if no viruses are identified, allow the download to the wireless subscriber device 101. Thus the virus checker 119 in some embodiments monitors for viruses during network downloads to the wireless subscriber device 101 and prevents the wireless subscriber device 101 from being infected by the viruses. The virus checker 119 can also remove a virus or repair damage caused by a virus in some situations, in either the network downloads or memory images. Note that the virus checker, when updated with new virus information, for example a new virus or new way of detecting a known virus, can be used to re-scan the backup data or images to insure that the new virus is not found in these images or backup data. If a virus is found these images can be repaired and if the download log and other records indicate that a subscriber device is or may be infected processes can be taken to correct those problems.

Referring now to FIGS. 2 and 3, a block diagram and exemplary display of the wireless subscriber device 101 suitable for communication within communication system 100 in accordance with an illustrative embodiment will be discussed and described. The wireless subscriber device 101 includes a controller 201 for managing many of the features and functions of the wireless subscriber device 101, including receive and transmit signal processing, message handling, user interface support, display properties, security options, etc. The controller 201 is coupled to a transceiver 202 for receiving and transmitting radio signals in accordance with the air interface conventions. The controller includes a processor 203 coupled to a memory 207 where the processor 203 executes various programs stored in the memory in order to manage and control the operation and features associated with the wireless subscriber device 101. The wireless subscriber device 101 also includes a user interface 205 further including a display and controls. The display can optionally be constructed as a touch screen for direct “point and click” control of the features and functions of the wireless communications unit, including for example a micro web browser, phone book, etc as depicted in a known manner.

For example, when a subscriber or user powers up or otherwise operates the wireless subscriber device 101, the menu on the display 205 will include various information and options. By navigating the menu, a wireless subscriber can access many of the features built into the wireless subscriber device 101. One such feature is Internet and email access depicted as a micro browser 206 (shown by example in FIG. 3), which permits access to a suite of wireless data products and services including email as is known. Just as desktop computer users access and navigate the World Wide Web or Internet using a web browser, wireless subscribers can access the Internet using the micro browser 206. Wireless data services include, for example, sending and receiving e-mail and two-way messages, accessing an address book to obtain directions, checking weather and news, shopping for clothing and airline tickets, and viewing stock quotes.

When a wireless subscriber selects the micro browser feature 206 on the menu of the display 205 of the wireless subscriber device 101, a radio frequency (RF) signal is sent to the base station 103. The base station 103 receives the signal, sends the information to the balance of the cell network, specifically a controlling entity for the network such as a switch or switching center. The cell network then forwards the request for access to the download server 109, either directly or indirectly via the backup server 111. The air interface between the wireless subscriber device and the base station often uses a known wireless session protocol (WSP) and a wireless transaction protocol (WTP) for bandwidth conservation purposes. A variety of transport mechanisms, such as for example hypertext transfer protocol (HTTP), carry wireless data between the wireless subscriber device 101 and the download server 109 or at least a wireless gateway (not shown). Lower levels of the protocol rely on Internet protocols, such as TCP/IP and the like.

In some embodiments the request for access is directly routed to the download server and responses from the server are routed from the cell network to or through the backup server 111. The responses that are routed to, rather than through, the backup server 111 can be simultaneously routed to the wireless subscriber device. In this instance the backup server 111 can only monitor the state of the memory of the wireless subscriber device via effects on the memory image before versus after a download as will be discussed further below. When the response is routed through the backup server 111, the server can essentially act as a download gateway or firewall and can determine whether problems or anomalies, such as corruption of the memory will result from and thus abort or preclude the download. In other embodiments the initial request for access can be routed through the backup server 111 with all responses being returned through the backup server. Generally known techniques are used for routing IP messages from their origin to their destination and monitoring, intercepting, and redirecting such messages as appropriate.

The backup server 111 creates representations, such as a direct copy or information sufficient to restore a copy of the memory image (e.g. bit by bit contents of the memory) of a wireless subscriber device 101 in for example the backup memory 117 of the backup server 111 or other memory location co-located with the backup server or elsewhere chosen for archival purposes. Note that the memory image can be composed of various portions or software modules or images that result from these modules. Thus the information sufficient to restore a copy of the memory image can comprise one or more of a listing of relevant modules, corresponding images, locations or addresses for obtaining these modules or images, and so forth or some mixture of images and a listing of other modules. The back up server can query each respective subscriber device to obtain an initial configuration or listing of relevant modules and keep track thereafter as the device is updated or configured or alternately query the device from time to time. In this way, it is possible to handle catastrophic errors, such as for example, loss of or corruption of memory content for one or more modules due to for example a virus, other malicious file, or other anomaly that may occur. By maintaining in the backup server 111 or elsewhere a representation of the current and one or more previous memory images of the wireless subscriber device 101 contents, the wireless subscriber device may not need to have as much processing and data storage capability as would be the situation if these backup images were maintained within the device.

Downloads requested by the wireless subscriber device 101 from the download server 109 in certain embodiments are first routed to the backup server 111. The backup server 111 can initially save a time-stamped archived representation of the memory image of the wireless subscriber device 101, as it existed before initiating or accepting and processing the download. Coincident with the download to the wireless subscriber device 101, a resultant memory image is created in the backup server 111 that is identical to the memory (memory image) in the wireless subscriber device 101 after the download. While the download of the information occurs, the backup server 111 nearly simultaneously creates a current, after download and processing, representation of the memory of the wireless subscriber device 101. This is possible by insuring that the backup server 111 knows the original state of the memory of the wireless subscriber device 101, using for example known mirroring techniques, and has knowledge of the processing performed while or as a result of downloading the new information or file. The backup server 111 can be executing a handset emulation routine that corresponds to the particular subscriber device to ensure that the version of the memory created is the same as the resultant contents of the memory 207 in the wireless subscriber device 101. The backup server 111 by virtue of the virus checker and it associated update routines may be aware of certain viruses and can prevent an unnecessary virus infection from being downloaded to the wireless subscriber device 101.

When an anomaly, such as a virus, the results of a virus, or other problem, is detected, a wireless subscriber may be alerted and the backup server 111 and earlier memory images can be used to facilitate restoring the memory or portion of the memory 207 in the wireless subscriber device 101 to a previous non-infected state. The virus checker 119 using known push techniques can essentially force restoration of an original memory state of the wireless subscriber device 101 if the virus checker 119 detects a virus. The virus checker 119 distributes fixes as appropriate depending on the subscriber device status when a virus infects the wireless subscriber device 101. As is known, the virus checker 119 is continuously or from time to time updated with virus information for use in determining whether the wireless subscriber device 101 has been infected with a virus. As noted above when new virus information becomes available existing archived copies of the subscriber memory image can be re scanned and corrective action taken as needed.

The monitor device 115, in some embodiments, can further include a virus elimination program to, for example eliminate viruses from the wireless subscriber device 101 or memory thereof or from downloads prior to causing any problems at the subscriber device. The backup server 111 keeps periodic representations of the memory images. The monitor device 115 purges the representations of memory images of the wireless subscriber device 101 on a predetermined periodic basis. As noted earlier, the monitor device 115 formulates a memory image of the wireless subscriber device 101 both before and during or after memory updates at the wireless subscriber device 101 as the backup data.

The monitor device 115 periodically creates copies of memory images of the wireless subscriber device 101 in the backup memory 117 as the backup data. The backup memory 117 stores data on memory changes to the wireless subscriber device 101 as a part of the backup data. The backup memory 117 stores previous uninfected versions of software for replacing corresponding infected versions of the software when necessary.

The backup server 111 maintains an audit trail of the changes to the memory 207 as they occur. The data on memory changes may include for example, an original memory state and/or a log of memory changes such as software updates at the wireless subscriber device 101. Thus, the backup server 111 therefore acts as an intermediary software manager point of safety between the wireless subscriber device 101 and the World Wide Web. The backup server 111 may also act as a third party monitor since it keeps a current version of virus checking software and can check for viruses, normally within downloads or downloaded files while being connected to the download server 109 and the cell network 107.

The backup server 111 is able to download virus definitions and fixes to each of the wireless subscriber devices, such as the wireless subscriber devices 101 in the communications system 100. Virus checking software may be hundreds of kilobytes in length. The backup server 111 eliminates any need for the wireless subscriber device 101 to have a virus checker, to run one, or to download or otherwise update one. The backup server 111 conveniently keeps numerous versions of the memory 207 of the wireless subscriber device 101 in the cell network 107 infrastructure or other network location where processing and storage are cheap. Virus detections will be faster and fixes can be distributed or be targeted to only actual infected wireless subscriber devices. Although the backup server 111 is described in reference to wireless communications systems, a similar backup server may be used with wired devices.

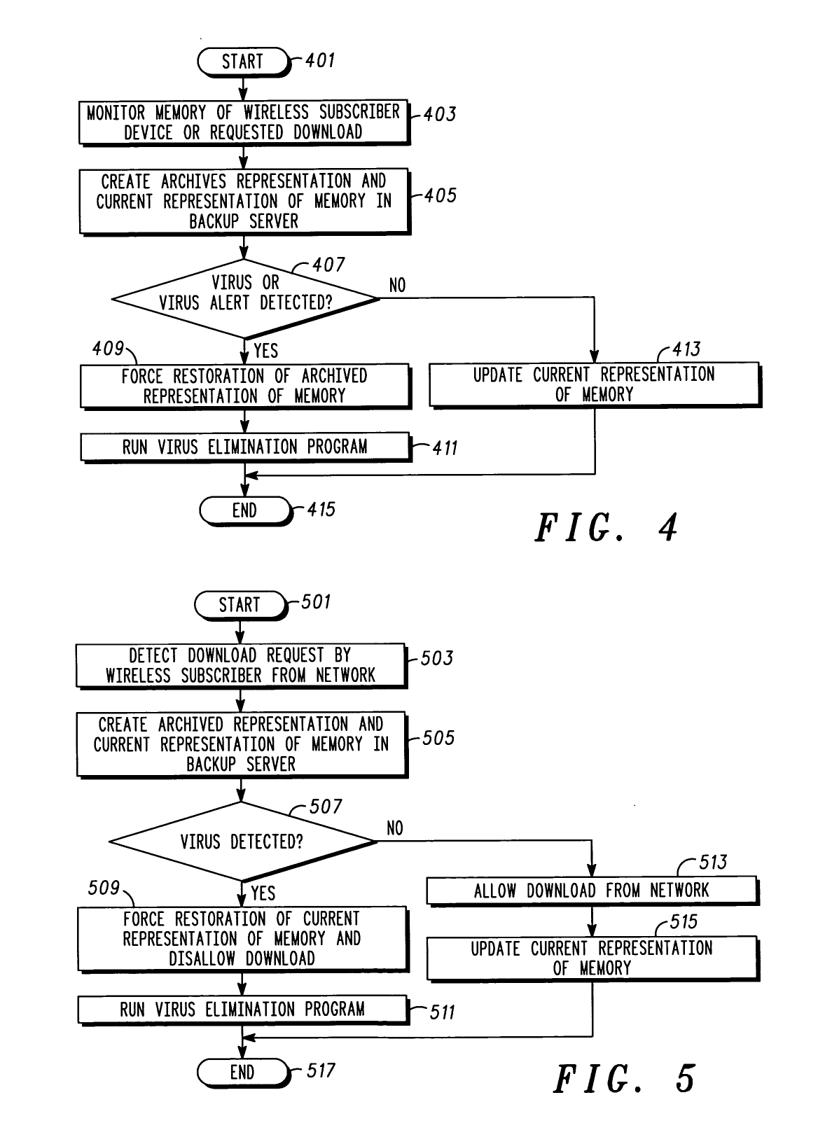

FIG. 4 is a flow diagram of the methodology used to maintain the integrity of the memory of a wireless subscriber device 101. The method starts at 401, and will be described in terms of the apparatus discussed above, though clearly the method can be practiced with other apparatus and structures. Essentially the backup server 111 or functionally similar entity periodically checks versions of the memory 207 of the wireless subscriber device 101 with for example, a continuously updated virus checker 119 to maintain or facilitate maintaining the integrity of a memory 207 of a wireless subscriber device 101. The checking of the current images of the memory could be in accordance with a log of software downloads or actual data stored in the wireless subscriber device 101 (e.g., phone book) or both.

At 403, the memory 207 of the wireless subscriber device 101 or the download information is monitored by the backup server 111. The backup server 111 remotely maintains at least one archived representation and at least one current representation of the memory 207 of the wireless subscriber device 101 at 405. Remotely maintaining at least one archived representation and at least one current representation of the memory 207 of the wireless subscriber device 101 also includes remotely maintaining a log of changes to the memory 207 of the wireless subscriber device 101 for use in the determining whether the memory 207 of the wireless subscriber device 101 has been compromised with a particular download and thus perhaps occurrence of a virus or a virus alert.

The backup server 111 determines whether the memory 207 of the wireless subscriber device 101 has been compromised, for example, by or upon occurrence of a virus or a virus alert at 407. The backup server 111 causes or facilitates the restoration of the memory 207 of the wireless subscriber device 101 using one or more archived memory representation of the wireless subscriber device 101 at 409, if the memory 207 has been compromised. A virus elimination program that eliminates the virus or fixes damage done by a virus is run at 411. If the memory 207 of the wireless subscriber device 101 has been compromised, the memory 207 of the wireless subscriber device 101 is updated. The process ends at 415. If at 407 there is no indication of an anomaly, such as a virus or virus alert the current representation of the memory is updated at 413. As new information on virus becomes available archived or back up copies of the memory or memory image can be re scanned for viruses.

FIG. 5 is a flow diagram of the methodology used to backup the memory of a wireless subscriber device 101. The method begins at 501, and shows a method whereby a memory 207 of the wireless subscriber device 101 is backed up by an infrastructure, i.e., a facility responsible for providing this service such as a wireless service provider or other network based third party. The backup server 111 can be part of the infrastructure of the cell network that supports wireless subscriber device 101 or other network based entity. The wireless subscriber may or may not control the content of what can be downloaded. The backup server 111 detects a request by the wireless subscriber device 101 for a network download at 503. At 505, an archived representation and a current (e.g. after download) representation of a memory image of the wireless subscriber device 101 are remotely created in the backup server 111 or similar facility prior to or during the network download. In this way, the infrastructure archives and in some embodiments timestamps the various archived and current images of the memory 207 of the wireless subscriber device to keep track or log what information is in the memory of the wireless subscriber device 101. Therefore, the wireless subscriber or backup server can re-create what, where, and when something went wrong with a download. This can be done logically or algorithmically as known to determine what instruction or file was used to create the memory representations over a period of time and thus where and when something has gone awry. This method has the advantage of backing up data, keeping one copy of the download, and recording which subscriber has downloaded, all in the infrastructure, e.g. backup server thus eliminating the processing capacity and memory capacity otherwise required at each subscriber device. The facility can keep track of what each wireless subscriber device is doing and can provide an appropriate fix if malicious software is detected.

At 507, the backup server 111 checks the download for a virus during or after the network download. The backup server 111 checks the modified representation of the memory image, resulting from the network download, for viruses or virus results. Note in some embodiments where downloads are only monitored rather than screened the download may take place. If the download is merely monitored, the wireless subscriber device or memory thereof may be infected or otherwise compromised when a virus or other malicious files are detected at 507. In this event, the backup server 111 facilitates restoration of the wireless subscriber device 101 using for example the latest one of the archived representations of the memory image. If the backup server is acting as a gateway or checkpoint and detects a virus, etc at 507, the server can intercede and the download to the subscriber device can be disallowed. If the current representation of memory is compromised, it can be restored using an archived copy at 509.

If desired and available and capable a virus elimination program can be executed at 511 to eliminate the virus from the download or downloaded information, current representation of memory, or from the subscriber device when the download was not interrupted. In other words if the modified representation of the memory image (current representation) is checked for viruses after the network download and the backup server 111 or virus checker detects a virus, the virus, in some instances, can be eliminated from the wireless subscriber device 101 and current representation by the virus elimination program. Note that new virus information may become available from time to time and this new information can allow a better scan for known viruses as well as allow for detecting new viruses or other forms of malicious code. As the new information becomes available it may be prudent to re-check the modified representation or the various archived representations of the memory image for viruses. When or if a virus is detected, the virus could be eliminated from the modified representation or the archived representation of the memory image and the wireless subscriber device if the virus has infected the device.

When the backup server 111 checks the modified representation of the memory image or current image for viruses after a download, the backup server 111 as noted earlier can intercede or interrupt or not allow the download to the subscriber device. If no virus is detected at 507, the backup server 111 allows the download at 513 and the current representation of the memory is updated at 515 if needed and not already performed at 505. The process ends at 517.

There are various alternatives for interceding in the download if a virus is detected. One such alternative, if the subscriber device has already been compromised, given that the wireless subscriber device 101 has a saved or archived version of the memory 207 when it was not infected, is use this archived version to restore the memory image. Alternatively, as discussed above the backup server 111 maintains a copy of previous versions for a future download of an uninfected version. Alternatively, the backup server 111 may provide information so that the wireless subscriber device 101 can take a reference copy of software downloads and update it with known uninfected updates (e.g., a partial audit trail stopping at the virus download). Alternatively, the backup server 111 may push a virus elimination program that, when run, eliminates the virus from the wireless subscriber device 101. Any fix to the wireless subscriber device 101 is also done in the backup server 111 so that when complete, the version of software in the wireless subscriber device 101 matches the version and thus is known by the backup server 11.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A backup server for a wireless subscriber device comprising:
a transceiver for enabling network communication with the wireless subscriber device;
a monitor device, coupled to the transceiver, for monitoring the wireless subscriber device to detect whether a memory of the wireless subscriber device has been compromised; and
a backup memory coupled to the monitor device for storing backup data related to a memory of the wireless subscriber device as determined by the monitor device.

2. The backup server of claim 1, wherein the backup memory is for storing data corresponding to memory changes in the wireless subscriber device as the backup data.

3. The backup server of claim 2, wherein the data corresponding to memory changes comprises one of an original memory state and a log of memory changes at the wireless subscriber device.

4. The backup server of claim 1, wherein the monitor device includes a virus checker for protecting the wireless subscriber device against viruses.

5. The backup server of claim 4, wherein the virus checker is operable for restoration of an original memory state of the wireless subscriber device when the virus checker detects a virus.

6. The backup server of claim 5, wherein the backup memory is further for storing previous uninfected versions of software for replacing corresponding infected versions of the software when necessary.

7. The backup server of claim 4, wherein the monitor device further includes a virus elimination program to eliminate viruses from the wireless subscriber device.

8. The backup server of claim 4, wherein the virus checker is further for monitoring for viruses during network downloads to the wireless subscriber device and for preventing the wireless subscriber device from being infected by the viruses.

9. The backup server of claim 4, wherein the virus checker is further for distributing fixes when a virus infects the wireless subscriber device.

10. The backup server of claim 4, wherein the virus checker is updated with new virus information for use in determining whether the wireless subscriber device has been infected with a virus.

11. The backup server of claim 10 wherein the virus checker, when updated with the new virus information, is used to re-scan the backup data to insure that a new virus is not found in the backup data.

12. The backup server of claim 1, wherein the monitor device is for periodically creating copies of memory images of the wireless subscriber device in the backup memory as the backup data.

13. The backup server of claim 12, wherein the monitor device is for purging the copies of memory images of the wireless subscriber device on a predetermined basis.

14. The backup server of claim 1, wherein the monitor device is for duplicating a memory image of the wireless subscriber device after memory updates at the wireless subscriber device as the backup data.

15. A method for maintaining integrity of a memory of a wireless subscriber device, comprising:
remotely maintaining an archived representation and a current representation of the memory of the wireless subscriber device;
determining whether the memory of the wireless subscriber device has been compromised upon occurrence of one of a virus and a virus alert; and
causing the memory of the wireless subscriber device to be restored with the archived memory representation of the wireless subscriber device if the memory of the wireless subscriber device has been compromised.

16. The method of claim 15 further comprising, monitoring the memory of the wireless subscriber device for virus infection prior to determining whether the memory of the wireless subscriber device has been compromised upon occurrence of one of a virus and a virus alert.

17. The method of claim 15, wherein the remotely maintaining the archived representation and the current representation of the memory of the wireless subscriber device further comprises remotely maintaining a log of changes to the memory of the wireless subscriber device for use in the determining whether the memory of the wireless subscriber device has been compromised upon occurrence of one of a virus and a virus alert.

18. A method for backing up a memory of a wireless subscriber device, comprising:
detecting a request by the wireless subscriber device for a network download;
remotely creating an archived representation of a memory image of the memory; and
remotely creating a modified representation of the memory image of the wireless subscriber device during the network download.

19. The method of claim 18, further comprising:
checking the modified representation of the memory image for corruption; and
restoring the wireless subscriber device with the archived representation of the memory image when the checking the modified representation of the memory image for corruption results in detection of an abnormality.

20. The method of claim 18, further comprising:
checking the modified representation of the memory image for viruses; and
eliminating a virus from the wireless subscriber device when the checking of the modified representation of the memory image for viruses after the network download results in detection of a virus.

21. The method of claim 20, wherein the eliminating a virus from the wireless subscriber device comprises eliminating a virus from the wireless subscriber device by enabling a virus elimination program.

22. The method of claim 20, further comprising
re-checking one of the modified representation and the archived representation of the memory image for viruses whenever new virus information is available and
when a virus is detected, eliminating the virus from the one of the modified representation and the archived representation of the memory image and the wireless subscriber device if it is infected by the virus.

23. The method of claim 18, further comprising:
checking the modified representation of the memory image for viruses during the network download; and
interceding during the network download when the checking of the modified representation of the memory image for viruses during the network download results in detection of a virus.

24. The method of claim 23, wherein the interceding during the network download when the checking of the modified representation of the memory image for viruses during the network download results in detection of a virus comprises one of preventing the network download and eliminating the virus from the network download.
